(19) United States
(12) Patent Application Publication
(10) Pub. No.: US 2010/0153693 A1
(43) Pub. Date: Jun. 17, 2010

(54) CODE EXECUTION WITH AUTOMATED DOMAIN SWITCHING

(75) Inventors: Jonathon Michael Stall, Bothell, WA (US); Gregg Bernard Miskelly, Seattle, WA (US); Richard Michael Byers, Bellevue, WA (US); Eric Hurwitz Feiveson, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/337,431

(22) Filed: Dec. 17, 2008

(51) Int. Cl. G06F 9/00

(52) U.S. Cl. 712/229; 712/E09.003

(57) ABSTRACT

Within the field of computing, many scenarios involve the execution of an instruction set within a domain that is configured to support an execution context. However, various portions of the instruction set may be preferably executed in different domains, such as for promoting performance and for providing debugging features like the ability to simulate execution of a debuggee function without incurring side-effects in the debuggee. Portions of the instruction set may therefore be executed in different domains by inserting domain switch points in the instruction set specifying a target domain. The instruction set may then initiate execution in an initial domain, and upon reaching a domain switch point, may transition to the target domain. In some embodiments, the domain switch points may be automatically inserted into the target instruction set based on various domain switch criterion, such as performance, reliability, and affinity of an instruction with a particular domain.

### BACKGROUND

Within the field of computing, many scenarios involve the execution of an instruction set (such as a program) in one of several domains that may differ in certain properties. For example, a native execution domain may execute fully compiled instructions directly on the processor; an interpretive executing domain may interpret partially compiled or uncompiled instructions just before execution on the processor; a virtual execution domain may define a virtual machine in which the instructions are executed on a virtual processor; and a debugging execution domain may attach various monitoring aspects to the executing instructions. The instruction set may therefore be executed by choosing an execution domain (such as a debugging mode, which may permit inspection, tracing, and breakpointing, or a fully compiled, native execution domain) and executing the instruction set within the domain.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The executing of an instruction set within a domain may present some advantages with respect to other domains, but may also present some disadvantages with respect to other domains. As a first example, an instruction set may contain some instructions of interest that a user wishes to monitor, such as through a debugging engine, but may also contain many instructions that are performance-intensive but are not of interest. Executing the instruction set in a debugging domain may permit monitoring of the instructions of interest, but may induce undesirably or unacceptably slow execution of the performance-intensive instructions. As a second example, an instruction set may contain both untrusted instructions that are to be monitored via runtime inspection during interpretive execution and trusted instructions that are not monitored and may natively execute. Executing this instruction set in an interpretive executing domain may yield undesirably or unacceptably slow performance of the trusted instructions, while executing the instruction set in a native execution domain may be incompatible with runtime inspection.

An alternative technique for executing such instruction sets involves an automated switching of domains during the execution of the instruction set. Within the instruction set (e.g., at particular instructions or portions thereof), domain-switch points may be created that specify a transitioning of the execution of the instruction set to a particular execution domain. For example, a debugger may place domain-switch points before instructions of debugging interest that specify a transition to a debugging domain, and may place other domain-switch points after such instructions that specify a transitioning out of the debugging domain (e.g., to a natively or interpretive executing domain.) Upon reaching a domain-switch point while executing the instruction set, the execution domain of the instruction set may be switched before executing the next instruction in the instruction set. The insertion of domain-switch points may be automatically performed, e.g., based on the nature and security of the instructions, and may therefore yield an improved manner of executing of the instruction set.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario involving the execution of a target domain set in one of several domains available in a computing environment.

FIG. 2 is an illustration of an exemplary scenario involving the execution of a target domain set in a plurality of several domains available in a computing environment.

FIG. 3 is a flow chart illustrating an exemplary method of executing in at least two domains a target instruction set stored in a memory of a computer having a processor.

FIG. 4 is a component block diagram illustrating an exemplary system for executing in at least two domains a target instruction set stored in a memory of a computer having a processor.

FIG. 5 is an illustration of several techniques for inserting domain switch points into a target instruction set and for detecting the reaching of a domain switch point during the execution of the target instruction set.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In the field of computing, the execution of an instruction set (such as a program) may occur within a particular domain, which may define many aspects of the execution. Respective domains may therefore execute the instruction set differently in furtherance of particular advantages, such as performance, safety, and inspection capabilities. For example, a first domain may be configured for interpretively executing a set of partially compiled or uncompiled instructions on the processor, such as by examining respective instructions and choosing corresponding fully compiled instructions for execution. This first domain might be helpful, e.g., for examining the code for errors or vulnerabilities (such as bad pointer references) and for configuring the code for the particular computing environment (such as the available hardware of the computing environment; however, the on-the-fly interpreting may impact the performance of the executing code. A second domain may be configured for natively executing a set of fully compiled instructions on the processor, which may provide high performance, but may not be amenable to oversight and may be less able to adapt to the available hardware. A third domain may be configured for executing the instructions in a virtual machine having a set of emulated hardware components and a separate memory store, which may permit execution of untrusted code without jeopardizing the local computing environment. A fourth domain may be configured for executing the instructions in a debugging context, where the executing is states of particular data objects may be monitored, the occurrence of particular events may be logged, and side-effects may be simulated without perturbing the state of the debuggee. Computing environments may implement the set of domains in various ways; as one example, the computing environment may provide a set of runtimes, each of which may be differently configured to execute an instruction set in a different context (e.g., a debugging runtime, an interpretive executing runtime, and a native executing runtime.)

An instruction set may be executed within a particular domain. For example, while developing a particular application, a developer may choose to execute the instruction set in a debugging context or in a release context. In order to perform this selective executing, the computing environment (e.g., a runtime provided therein) may load the instruction set within an appropriate domain and may initiate execution in order to run the application in the selected context. Other domains may also be available for servicing other contexts. For example, an interpretive executing domain may be suitable for interpretively executing an instruction set, such as a partially compiled or compiled instruction set, and a virtual executing domain may be suitable for executing an untrusted instruction set within a virtual computing environment in partial or complete isolation of other aspects of the native computing environment. Some operations may only be valid in a single domain. By providing a set of domains and loading an instruction set into an appropriate domain for execution, the computing environment may therefore permit users to alter the manner of executing the instruction set according to a semantic context selected by the user.

However, in some instruction sets, a first subset of instructions may be better executed in a first domain, while a second subset of instructions may be better executed in a second domain. As a first example, an instruction set may involve a small set of instructions that are of interest to a developer, such as an identified set of instructions that are causing an error or a logical fault. The developer may wish to execute these instructions within a debugging executing environment in order to inspect or monitor the performance of such instructions. However, it may be preferable to execute the rest of the instruction set without the debugging context, which may significantly increase overhead and reduce performance. If the non-debugging instructions are of a high-performance nature (e.g., executing with tight time constraints that may be compromised by unnecessary debugging overhead; or executing a large number of times, such as in a deeply nested loop, and therefore exacerbating the performance penalty of the debugging context), then executing the entire instruction set in a debugging context may be undesirable or prohibitive. As a second example, an instruction set may involve both a trusted code portion and an untrusted code portion (e.g., a pluggable architecture that may insert third-party code into a tightly controlled application.) It may be desirable to execute the untrusted code portion in an isolation mechanism, such as a virtual computing environment, in order to reduce the avenues for compromising the native computing environment. However, it may be undesirable to run the trusted code portion in the virtual computing environment, and the untrusted code portions may be too deeply and pervasively embedded in the trusted code portion to devise an architectural solution that isolates the untrusted code portion as a discrete module to be executed in the virtual computing environment.

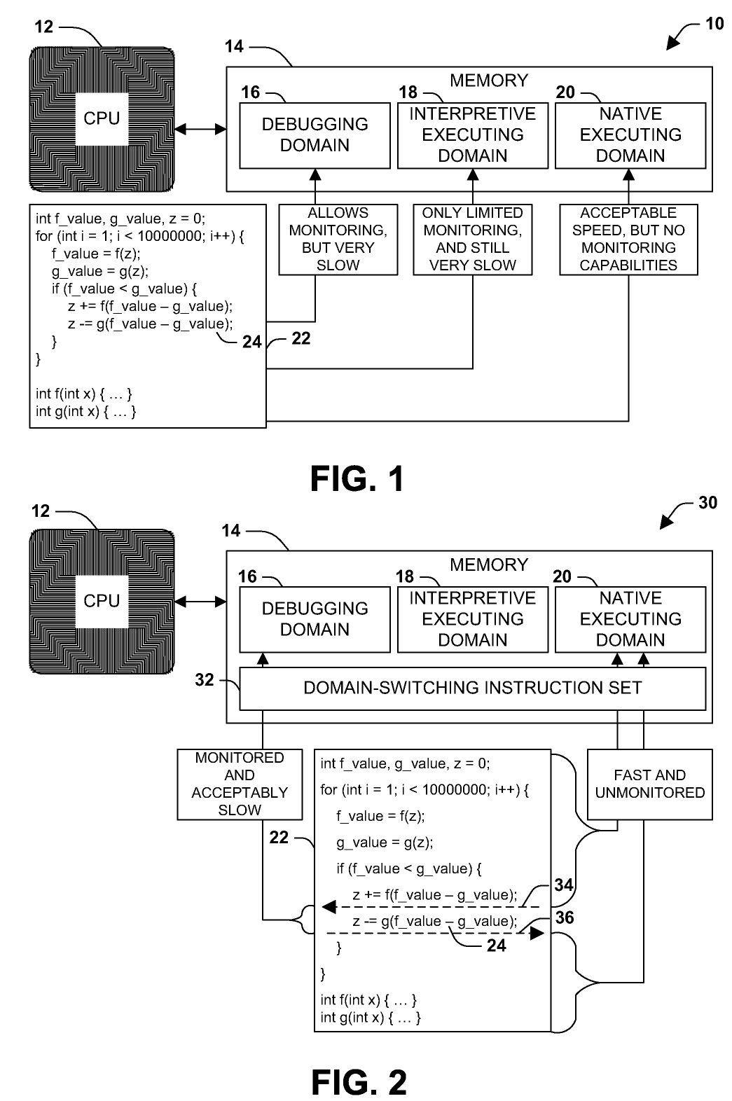

FIG. 1 illustrates a first such example in an exemplary scenario 10 featuring a computing environment that comprises a processor 12 and a memory 14. Within the memory 14 may be represented a set of domains, such as a debugging domain 16, an interpretive executing domain 18, and a native executing domain 20; these domains may be embodied in many forms (e.g., as one or more execution-supporting runtimes; as one or more processes within which code may execute; or even as one or more hardware drivers or configurations, such as a processing mode applicable to the processor 12 or a configuration of an FPGA.) Within the computing environment of this exemplary scenario 10, an instruction set to be executed on the processor 12 may be loaded within one of the domains, and may be executed in the corresponding context. For example, a source code loaded into the native executing domain 20 may be wholly compiled into native instructions (such as machine-language opcodes) and then natively executed. Alternatively, the source code may be loaded into the interpretive executing domain 18, which may step through the instructions of the source code, and may inspect each instruction for safety before compiling it on a just-in-time basis for execution. As a second alternative, the source code may be loaded into the debugging domain 16, which may apply various debugging techniques to the source code and executing (e.g., by inserting breakpoints into the source code, hooking function invocations, and attaching monitoring processes for inspecting values of interest, such as the call stack.)

However, in the exemplary scenario 10 of FIG. 1, a target instruction set 22 is presented that may present difficulties in the selection of a single domain for execution. In this target instruction set 22, a particular loop is executed a very large number of times, and each iteration involves some computationally intensive mathematical operations (referenced as f(x) and g(x).) An instruction of interest 24, involving an invocation of the g function and an assignment to the z variable, may be identified by a developer, e.g., a function that is producing unexpected values in particular circumstances. The developer may therefore wish to monitor the instruction of interest 24 during an execution of the target instruction set 22. The developer may therefore attempt to execute the target instruction set 22 within the debugging domain 16, which may attach a standard set of debugging techniques to the execution of the target instruction set 22. However, the debugging techniques might attach to the entire target instruction set 22, and may incur a significant performance penalty on each instruction. For example, a debugger may attempt to monitor accessing of the z variable used in the instruction of interest 24, but this variable is frequently accessed in other portions of the target instruction set 22; the debugger may attempt to hook the g function referenced in the instruction of interest 24, but this may also hook the earlier (and possibly much more frequent) invocation of the g function elsewhere in the instruction set 24; and the debugger may attempt to monitor the occurrence of the instruction of interest 24 by frequently checking the instruction pointer, but this may involve millions of accesses (as the instruction set progresses through the large number of iterations) and may incur a significant performance penalty. Alternatively, the target instruction set 22 may be loaded into the interpretive executing domain 18; however, this domain may offer much more limited monitoring options (such as stepping through the target instruction set 22 to detect the executing of the instruction of interest 24, which may still incur a significant performance penalty. As a second alternative, the target instruction set 22 may be loaded into the native executing domain 20, but this may not offer an acceptable monitoring technique. Because no domain in this computing environment offers an acceptable tradeoff of monitoring and performance, the developer may have to redesign the target instruction set 22 to achieve the desired monitoring or seek to create a new domain.

An alternative model for managing the execution of instruction sets in different contexts involves a hybrid domain execution technique, wherein a first portion of the instruction set executes in a first domain while a second portion of the instruction set executes in a second domain. In some scenarios, the execution contexts may be mutually exclusive (e.g., the operating constraints of a release execution context may be incompatible with the operating constraints of a debugging execution context), but in other scenarios, different portions of the target instruction set might be compatibly executed in different execution contexts and different domains representative thereof. One technique that may be devised to implement this model involves a domain transitioning mechanism, wherein a domain switch point may be identified in the instruction set, such as between an instruction to be debugged and an instruction not to be debugged, or between a trusted instruction portion and an untrusted instruction portion. The computing environment (such as a runtime configured to execute the instruction set) may initiate the executing of the instruction set in an initial domain. Upon reaching a domain switch point in the instruction set, the computing environment may transition the execution of the instruction set to a target domain specified by the domain switch point. Several domain switch points may be inserted in the instruction set to achieve the transitioning of the execution of the instruction set among several domains. Moreover, this insertion may be automated, e.g., by identifying particular types of instructions that are better executed in different domains and inserting domain switch points before such instructions specifying a transition of the execution to the preferred domain, without involving the user or developer in such decisions and resource overhead.

FIG. 2 illustrates an exemplary scenario 30 similar to FIG. 1, but wherein the computing environment manages the loading of a target instruction set 22 into domains available in the memory 14 through a domain-switching instruction set 32. For example, the domain-switching instruction set 32 may insert a first domain switch point 34 before the instruction of interest 24, indicating that the execution is transitioned to a first target domain (such as the debugging domain 16) and a second domain switch point 36 after the instruction of interest 24, indicating that the execution is transitioned to a second target domain (such as the native executing domain 20.) The domain-switching instruction set 32 may then initiate the execution of the instruction set 32 in an initial domain, such as the native executing domain 20. Upon reaching a domain-switch point in the target instruction set 22, the domain-switching instruction set 32 may then perform the domain switching task (for example, by suspending the process executing the code; migrating the binary and associated objects to the target domain, e.g., by attaching debugging techniques to the binary within a debugging domain; and restarting the process within the target domain.) By managing the executing of the target instruction set 22 in this manner, the domain-switching instruction set 32 thereby achieves the performing of the uninteresting instructions in the target instruction set 22 in a fast, unmonitored manner, and the performing of the instruction of interest 24 in an acceptably slow but adequately monitored manner. The domain-switching instruction set 32 thereby achieves the execution of different portions of the target instruction set 22 in different domains to apply a desirable set of features to the execution.

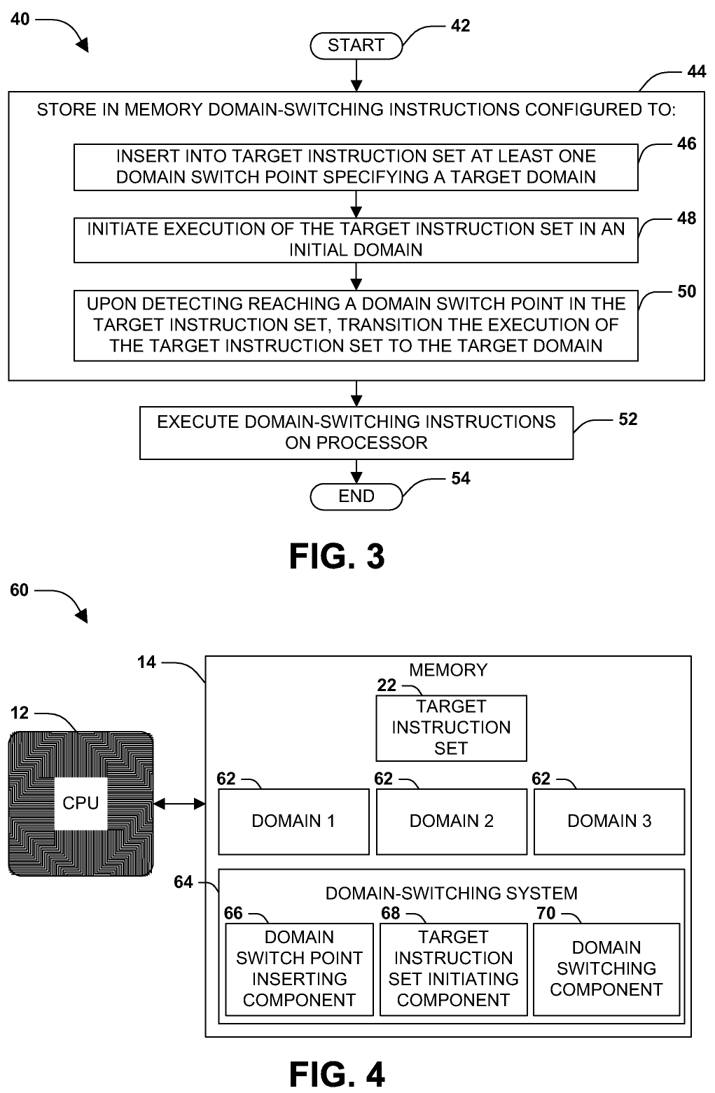

FIG. 3 illustrates a first embodiment of the techniques, comprising an exemplary method 40 of executing in at least two domains a target instruction set 22 stored in a memory 14 of a computer having a processor 12. The exemplary method 40 begins at 42 and involves storing 44 in the memory 14 a domain-switching instruction set 32 that achieves the domain-switching during execution of the target instruction set 22. This domain-switching instruction set 32 is configured to insert 46 into the target instruction set 22 at least one domain switch point 34 specifying a target domain. The domain-switching instruction set 32 is also configured to initiate 48 execution of the target instruction set 22 in an initial domain, which may be suitable for the first portion of instructions in the target instruction set 22. The domain-switching instruction set 32 is also configured, upon detecting reaching a domain switch point 34 in the target instruction set 22, to transition 50 execution of the target instruction set 22 to the target domain specified with the domain switch point 34. The domain-switching instruction set 32 thereby configures the target instruction set 22 to transition to a new domain at respective desirable points in the target instruction set 22, and handles the transitioning upon reaching such a domain switch point 34. The exemplary method 14 also involves executing 52 the domain-switching instruction set 34 on the processor 12. By performing the domain-switching instruction set 34 within the computing environment and on the target instruction set 22, the exemplary method 40 thereby achieves an execution of the target instruction set among a plurality of domains in a desirable manner, and so ends at 54.

FIG. 4 illustrates a second embodiment of the techniques presented herein, illustrated as an exemplary system 64 for executing in at least two domains 62 a target instruction set 22 stored in a memory 14 of a computer having a processor 12. The exemplary system 64 may comprise, e.g., instructions stored in the memory 14 (such as part of an operating system of the computer, or as a runtime component servicing the execution of instruction sets) to implement the domain-switching techniques discussed herein. The exemplary system 64 comprises a domain switch point inserting component 66, which is configured to insert into the target instruction set 22 at least one domain switch point specifying a target domain. The exemplary system 64 also comprises an instruction set initiating component 68, which is configured to initiate execution of the target instruction set 22 in an initial domain. The exemplary system 64 also comprises a domain switching component 70 configured, upon detecting reaching a domain switch point in the target instruction set 22, to transition execution of the target instruction set 22 to the target domain specified with the domain switch point. By applying these components to the execution of the target instruction set 22 on the processor 12 with respect to the domains 62 stored in the memory 14, the exemplary system 64 thereby applies the domain-switching techniques discussed herein to the execution of the target instruction set 22.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 40 of FIG. 3 and the exemplary system 64 of FIG. 4) to confer individual and/or synergistic advantages upon such embodiments.

A first aspect that may vary among embodiments of these techniques involves the types of domains between which the executing target instruction set 22 may be transitioned. As a first variation, the domains may represent various execution contexts. For example, the set of domains available in a computing environment may include a native executing domain configured to execute fully compiled machine instructions on the processor, which may achieve high performance but without monitoring and safeguarding capabilities. The set of domains may also include interpretive executing domain configured to step through the instructions of the instruction set and compile and execute particular instructions on a just-in-time basis. This domain may be advantageous for enabling tracing, inspection, monitoring, and instruction verification as a safeguard, and may also permit polymorphic interpretation of the instructions in view of various factors; however, the interpretive execution may incur a performance penalty, which may be prohibitive in code that is computationally intensive or has strict timing constraints. The set of domains may also include a virtual executing domain configured to execute instruction sets in a virtual computing environment, such as a virtual machine that is partially or wholly isolated from the native computing environment, or an emulated machine that is capable of executing instruction sets configured for a different computing environment than natively provided; while this technique may promote the security, compatibility, and isolation of executing instruction sets, a significant performance penalty may be incurred and resource consumption may be high. The set of domains may also include a debugging domain configured to apply one or more debugging techniques, components, or processes to the instruction set during execution (e.g., a monitor that watches, traces, and perhaps logs an aspect of the executing instruction set; a breakpointing component that inserts breakpoints and suspends and restarts execution of the instruction set upon reaching such breakpoints; and an inspection component that permits a developer to explore various aspects of the executing instruction set, such as objects and object properties.) While such techniques may facilitate the profiling and debugging of instruction sets, the debugging domain may incur significant performance and resource penalties in order to apply such techniques.

As a second variation of this first aspect, the architecture of the domains may be structured in the computing environment in different ways. For example, the domains may comprise different configurations of the operating system, which may permit a selection of an initial domain while initiating the execution of an instruction set, and between which an implementation of the techniques discussed herein may transition during the execution of the instruction set. As a second example, the domains may be implemented as respective runtimes stored and available within the computing environment, where each runtime is configured to manage the execution of instruction sets according to a particular context (e.g., a debugging context, a native executing context, an interpretive executing context, and a virtual execution context.) As a third example, the domains may comprise different configurations of an instruction set, such that an instruction set may be contextually configured (e.g., differently compiled, or associated at runtime with different resources, or executed on different components within the computing environment) based on the selected execution context; in this scenario, the techniques discussed herein may be implemented by configuring the target instruction set to switch contextual configurations (i.e., execution domains) for different portions of the instruction set. Those of ordinary skill in the art may devise many types and architectures of domains to which the techniques discussed herein may be applied.

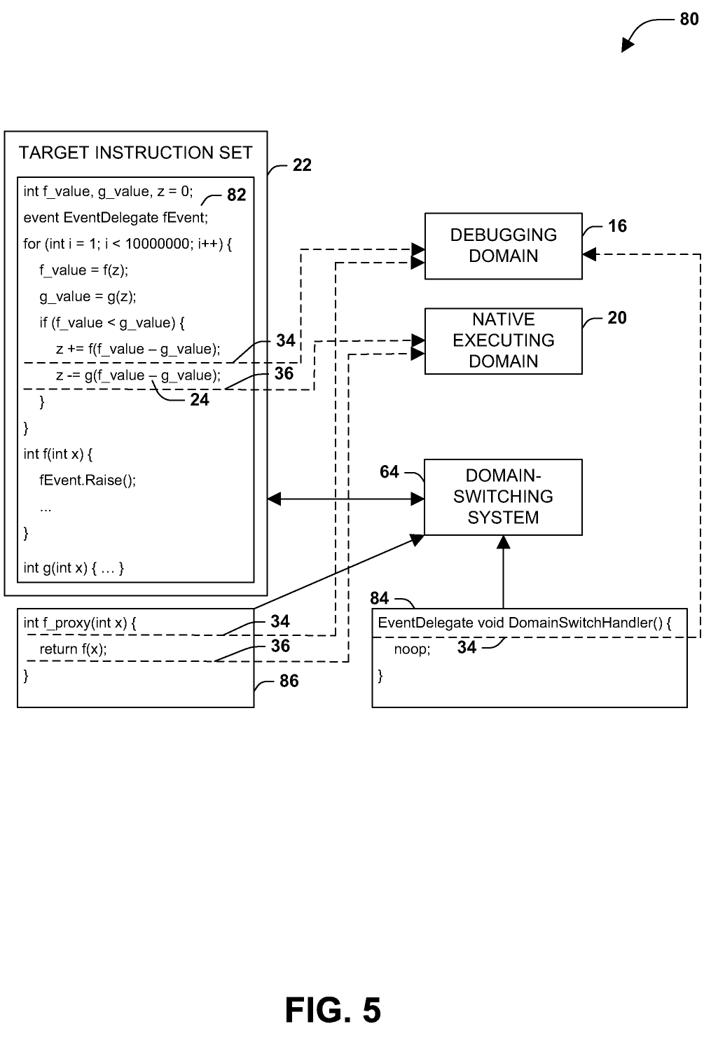

A second aspect that may vary among embodiments of these techniques relates to the manner of inserting domain switch points into the target instruction set, and the corresponding manner of detecting the reaching of a domain switch point during execution of the target instruction set. FIG. 5 presents an exemplary scenario 80 illustrating some various techniques for inserting such domain switch points in a target instruction set 22, which may be achieved by a domain-switching system 64 (such as illustrated in FIG. 4.) In a first variation, the domain-switching system 64 may insert a breakpoint at the domain switch point; e.g., in order to debug an instruction of interest 24, the domain-switching system 64 may insert a first breakpoint at a first domain switch point 34 just before the instruction of interest 24 that transitions the execution of the target instruction set 22 to the debugging domain 16, and a second breakpoint at a second domain switch point 34 that transitions the execution of the target instruction set 22 to the native executing domain 20. Such breakpoints may comprise, e.g., instructions inserted into the target instruction set 22 that suspend execution and notify the domain-switching system 64 of reaching the breakpoint, thereby implementing a detecting of the invocation of the breakpoint. Alternatively, the breakpoints may comprise the creation of a reference to a particular instruction in an execution monitor that monitors the instruction pointer as the target instruction set 22 executes in order to detect the invocation of the breakpoint. (Such monitoring might impose a performance or resource penalty, but such penalties might be smaller than that incurred by attaching a large set of debugging tools, such as may be implemented in the debugging domain 16, to the execution of the target instruction set 22.)

In a second variation, the domain switch points may be inserted by hooking at least one function invocation at the domain switch point with a handler, and the detecting may comprise receiving an invocation of the handler. For example, as illustrated in FIG. 5, the target instruction set 22 may comprise an event 82 that may be raised at a particular point in the target instruction set 22 (e.g., at the beginning of the f function.) The domain-switching system 64 may insert a breakpoint by associating an event handler 84 with the event 82 that is invoked when the target instruction set 22 raises the event, thereby allowing the domain-switching system 64 to detect the reaching of the domain switch point in the target instruction set 22. The event handler 84 may switch the execution of the target instruction set 22 to a target domain, such as the debugging domain 16.

In a third variation, the domain-switching system 64 may insert one or more domain switch points into the target instruction set 22 by introducing a proxy 86, such as a wrapper around a particular function or instruction while introducing one or more domain switch points. For example, a proxy 86 may be devised as a wrapper around the f function, such that the proxy 86 simply invokes the f function with the provided parameter and returns the result. However, the proxy 86 may be configured to transition the execution of the target instruction set 22 to a target domain, e.g., by including a first domain switch point 34 that transitions to the debugging domain 16 before the invocation of the f function and a second domain switch point 36 that transitions to the native executing domain 20 after the invocation of the f function. The domain-switching system 64 may insert these domain switch points by reconfiguring at least one instruction in the target instruction set 22 to invoke access the proxy 86. For example, the domain-switching system 64 may redirect a function pointer within the target instruction set 22 from the f function to the proxy 86 (except where the proxy 86 actually invokes the f function), or may substitute invocations of the f function within the target instruction set 22 with invocations of the proxy 86. The domain-switching system 64 may then detect the reaching of a domain switch point in the target instruction set 22 when the proxy 86 is invoked.

In a fourth variation, the domain-switching system 64 may define a domain switch controller, which may be configured to insert the at least one domain switch point in the target instruction set 22 based on at least one domain switch criterion. The domain switch controller may therefore automatically determine where to insert domain switch points, e.g., by identifying particular instructions that are suitably executed in a particular domain, and inserting a first domain switch point before such instructions specifying a transition to the target domain and a second domain switch point after such instructions specifying a transition out of the target domain (e.g., to a default domain, the initial domain, or a native executing domain.)

In identifying such instructions, the target switch controller may utilize many types of domain switch criteria. As a first example, the domain switch controller may choose instructions based on an operation type of an operation in the target instruction set 22. For example, if the target instruction set 22 is executing in a debugging context, the domain switch controller may identify operations invoked through an operating system interface (such as an API), and may insert domain switch points such that these operations are invoked in a native execution domain (which may execute the operations more quickly and may avoid unnecessary monitoring), while executing the remaining instructions in a debugging domain 16. As a second example, the domain switch controller may choose instructions based on a resource type of a resource referenced in the target instruction set 22. For example, if a developer wishes to monitor interactions of a client with a server, the domain switch controller may identify instructions that utilize network resources (such as network adapters, protocols, events, APIs, received or transmitted packets, etc.) and may insert domain switch points around such instructions that transition to a debugging domain 16, while the rest of the instructions in the target instruction set 22 are executed in the native executing domain 20.

As a third example of this fourth variation, the domain switch controller may identify instructions based on a performance criterion. High-performance instructions (which may execute extensively, with significant resource utilization, with tight timing constraints, etc.) may be executed in a faster execution domain (such as a native executing domain), while other instructions may be executed in a more heavily monitored domain, such as a debugging domain 16 or an interpretive executing domain 18. As a fourth example, the domain switch controller may identify instructions based on a reliability criterion. For example, domain switch points may be inserted around instructions that are known or suspected of failure in certain circumstances in order to transition the execution of the target instruction set 22 to the debugging domain 16 before executing such instructions, and to otherwise execute the target instruction set 22 in the native executing domain 20.

As a fifth example, the domain switch controller may identify instructions based on a security criterion. For example, domain switch points may be inserted around instructions that are untrusted in an otherwise trusted target instruction set 22 (e.g., third-party instructions that are inserted into a trusted API having a pluggable architecture) in order to transition the execution of the target instruction set 22 to an untrusted domain (e.g., a virtual execution domain, which may partially or wholly isolate the untrusted code, or an interpretive executing domain, where such instructions may be inspected prior to execution), and to otherwise execute the trusted target instruction set 22 in the native executing domain 20. As a sixth example, the domain switch controller may identify instructions based on an affinity of an operation for executing within a domain. For example, an operation in the target instruction set 22 may only be executable within a subset of the available domains; e.g., a low-level operation performed on a hardware device (such as a direct memory copy to a hardware buffer) may be incompatible with the capabilities of a virtual executing domain or a debugging domain 16. Instead, the domain switching controller may identify this operation as having affinity for a native executing domain 20, and may insert a domain switch point before the operation to transition to the native executing domain 20 (in case the target instruction set 22 is not already executing in this domain.) Those of ordinary skill in the art may devise many domain switching criteria whereby a domain switching controller may automatically insert domain switch points based on the types of instructions in the target instruction set 22 while implementing the techniques discussed herein.

A third aspect that may vary among embodiments of these techniques relates to the converting of objects during a domain switch. The instruction set may utilize an object while executing in a source domain, and may also utilize the same object after transitioning to a target domain. Because the target domain may format particular objects in a different manner than the source domain, the object may be converted for use in the target domain, e.g., by adding or removing members to an object, or by reformatting a primitive value (such as reformatting a 32-bit integer accessible in the source domain as a 64-bit integer accessible in the target domain.) Accordingly, where a domain switch point transitions between a source domain and a target domain, the domain-switching instruction set may be configured to convert one or more objects in the source domain according to an object format compatible with the target domain. This converting may be performed in many ways. In a first variation, the domain-switching instruction set may attempt to identify a preferred object format of the object that is compatible with or preferred by the target domain, and may attempt to convert the object to the identified object format. In a second variation, the domain-switching instruction set may invoke a converter that is configured to perform the converting of the object to the object format. For example, respective domains may be associated with a set of converters configured to convert an object from a native format (such as a standardized format for the object type) to an object format used or preferred in the respective domain. The domain-switching instruction set may, upon transitioning to a domain, select the appropriate converter from the domain for respective objects, and may invoke the converter to convert the object in the source domain according to an object format compatible with the target domain. In this variation, the converter may be supplied by the target domain, but other sources of an appropriate converter may include the domain-switching instruction set (which may comprise a set of converters configured to convert objects to particular object formats for use with a particular domain), the source domain (e.g., the source domain may supply a set of converters for converting the objects used by the instructions executed in the source domain to a standardized format), and a debugging domain (which may provide converters for transitioning between domains in an ad hoc manner selected by the developer.)

One problem that sometimes arises where objects are converted involves the loss of identity information. For example, if an object generated in a source domain is converted for use in a target domain during a transitioning of an instruction set to the target domain, and is then converted back for use in the source domain, the twice-converted object may not resemble the original object; and even if the objects are identical, the objects may nevertheless appear as two discrete instances of the object type. It may be helpful to include an instance identifier with each object that is copied to a converted object for use in the target domain in order to remember the source of the converted object (i.e., the original object.) In this example, the converting may comprise associating the instance identifier with the object converted according to an object format compatible with the target domain. This associating of the instance identifier may facilitate correct object identity comparisons in subsequent instructions; e.g., where the target instruction set comprises at least one instruction configured to compare the object with a second object associated with an instance identifier, the domain-switching instruction set may be configured to compare the object with the second object by comparing the instance identifier of the object with the instance identifier of the second object. By using the instance identifiers as the basis for comparison instead of other criteria (such as the memory addresses of the object and the second object, or the hashcode value computed over the contents of each object), this comparison may present fewer false negatives (e.g., a FALSE result for a comparison of the object and a twice-converted but otherwise identical object) and fewer false positives (e.g., a TRUE result presented for two distinct instances of an object that happen o comprise the same content.) Those of ordinary skill in the art may devise many ways of converting objects used in a source domain for use in a target domain during a domain switch while implementing the techniques discussed herein.

A fourth aspect that may vary among embodiments of these techniques involves the transitioning of the domain hosting the target instruction set upon completing execution of the target instruction set. It may be appreciated that when the target instruction set completes, additional processing may occur, e.g., garbage collection, post-triggers, and evaluation of the results of the target instruction set. Because it may be difficult to perform such operations if the target instruction set ends in one of several domains, it may be advantageous to configure implementations of these techniques (such as the exemplary domain-switching system 64 of FIG. 4) to transition execution of the target instruction set to a particular domain upon completion, such as the initial domain in which the target instruction set began execution. Moreover, if the target instruction set generated at least one object during processing (in any of several domains) that is available as a result object upon completion of the target instruction set, the implementation of these techniques may be configured to convert the at least one result object according to an object format compatible with the initial domain, such as described hereinabove. Those of ordinary skill in the art may devise many ways of concluding the execution of the target instruction set while implementing the techniques discussed herein.

A fifth aspect that may vary among embodiments of these techniques relates to a different interpretation of various instructions based on the current domain in which the target instruction set is executing. For example, with regard to an instruction that may perform an operation in a first domain, a second domain may define an equivalent operation that executes in the second domain in place of the operation. For example, a computationally intensive operation that may execute with acceptable performance in a native executing domain may be substituted with an instruction that performs a cursory or simulated operation that consumes less performance if the instruction is executed while the target instruction set executes in a debugging domain. This substitution may permit domains to execute instructions in domains that may otherwise be unable to execute (e.g., the high-performance operation may be unable to execute in the debugging domain, and the target instruction set may only logically proceed if the operation is simulated.) As another example, an instruction set executing in a debugging domain may include an operation that does not pertain to the debugging, and that executes undesirably slowly as a closely monitored instruction (such as a string or array operation with many safeguards against buffer overruns.) The safe but slow instructions may therefore be substituted with fast, native operations in a different domain (such as a native executing domain), and such substitution may reduce unnecessary safeguards while improving the performance of the instruction set. Those of ordinary skill in the art may devise many uses of instruction substitution based on a current execution domain of a target instruction set while implementing the techniques discussed herein.

A sixth aspect that may vary among implementations of these techniques involves the inspection of an executing target instruction set, which may be complicated by the variable domains (e.g., by the variable formatting of objects depending on the current execution domain of the target instruction set.) In some embodiments, this inspection may be promoted by providing a domain that is aware of the variable execution domain of the target instruction set, and that may inspect the target instruction set in view of the current domain and execution context. For example, a stack trace may be performed on a target instruction set by first querying for the current domain, and then conducting the stack trace in view of the protocol of the current domain. Thus, upon receiving a stack trace request while executing the target instruction set, the domain-switching system may select the stack trace domain among the at least two domains, and then execute the stack trace in the stack trace domain. Those of ordinary skill in the art may devise many techniques for inspecting the target instruction set, in view of the variable domain in which the instruction set executes, while implementing the techniques discussed herein.

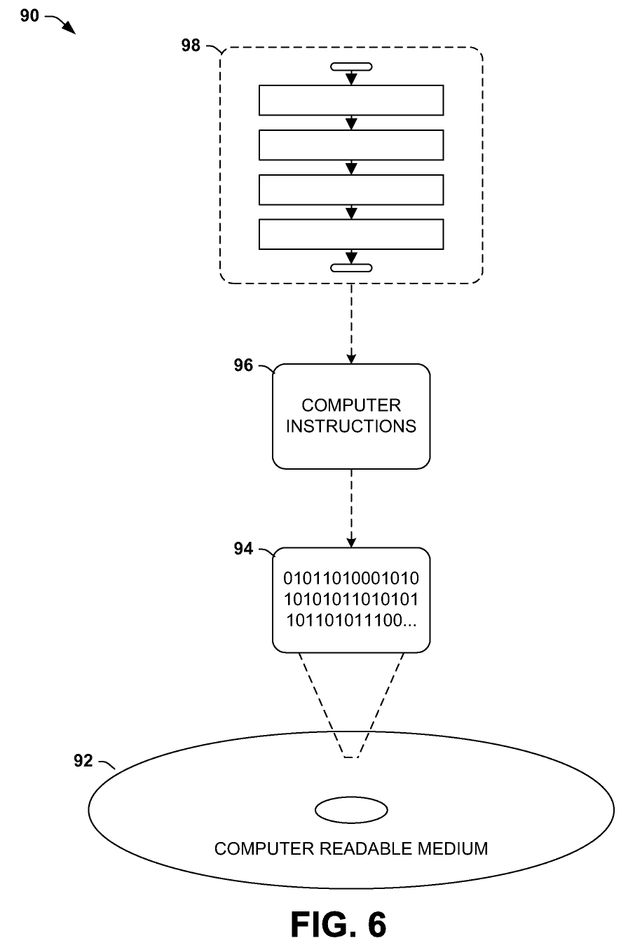

Still another embodiment involves a computer-readable medium comprising processor-executable instructions configured to apply the techniques presented herein. An exemplary computer-readable medium that may be devised in these ways is illustrated in FIG. 6, wherein the implementation 90 comprises a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. In one such embodiment, the processor-executable instructions 96 may be configured to perform a method of executing in at least two domains a target instruction set stored in a memory of a computer having a processor, such as the exemplary method 40 of FIG. 3. In another such embodiment, the processor-executable instructions 96 may be configured to implement a system for executing in at least two domains a target instruction set stored in a memory of a computer having a processor, such as the exemplary system 64 of FIG. 4. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

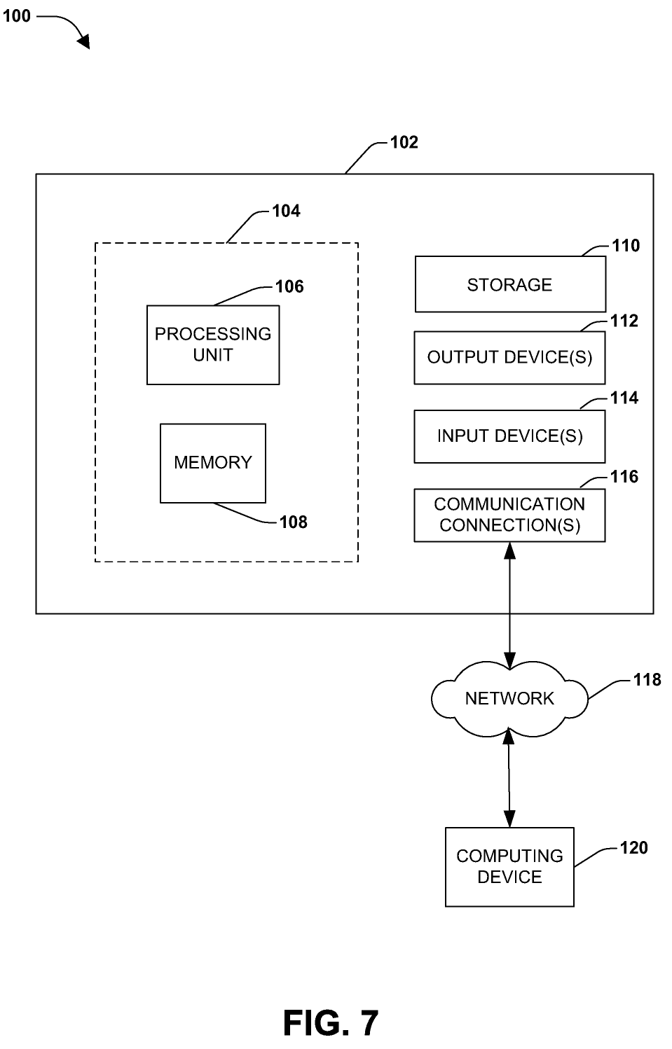

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 100 comprising a computing device 102 configured to implement one or more embodiments provided herein. In one configuration, computing device 102 includes at least one processing unit 106 and memory 108. Depending on the exact configuration and type of computing device, memory 108 may be volatile (such as RAM, for example), non-volatile (such as ROM, flash memory, etc., for example) or some combination of the two. This configuration is illustrated in FIG. 7 by dashed line 104.

In other embodiments, device 102 may include additional features and/or functionality. For example, device 102 may also include additional storage (e.g., removable and/or non-removable) including, but not limited to, magnetic storage, optical storage, and the like. Such additional storage is illustrated in FIG. 7 by storage 110. In one embodiment, computer readable instructions to implement one or more embodiments provided herein may be in storage 110. Storage 110 may also store other computer readable instructions to implement an operating system, an application program, and the like. Computer readable instructions may be loaded in memory 108 for execution by processing unit 106, for example.

The term “computer readable media” as used herein includes computer storage media. Computer storage media includes volatile and nonvolatile, removable and non-removable media implemented in any method or technology for storage of information such as computer readable instructions or other data. Memory 108 and storage 110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 102. Any such computer storage media may be part of device 102.

Device 102 may also include communication connection(s) 116 that allows device 102 to communicate with other devices. Communication connection(s) 116 may include, but is not limited to, a modem, a Network Interface Card (NIC), an integrated network interface, a radio frequency transmitter/receiver, an infrared port, a USB connection, or other interfaces for connecting computing device 102 to other computing devices. Communication connection(s) 116 may include a wired connection or a wireless connection. Communication connection(s) 116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 102 may include input device(s) 114 such as keyboard, mouse, pen, voice input device, touch input device, infrared cameras, video input devices, and/or any other input device. Output device(s) 112 such as one or more displays, speakers, printers, and/or any other output device may also be included in device 102. Input device(s) 114 and output device(s) 112 may be connected to device 102 via a wired connection, wireless connection, or any combination thereof. In one embodiment, an input device or an output device from another computing device may be used as input device(s) 114 or output device(s) 112 for computing device 102.

Components of computing device 102 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 102 may be interconnected by a network. For example, memory 108 may be comprised of multiple physical memory units located in different physical locations interconnected by a network.

Those skilled in the art will realize that storage devices utilized to store computer readable instructions may be distributed across a network. For example, a computing device 120 accessible via network 118 may store computer readable instructions to implement one or more embodiments provided herein. Computing device 102 may access computing device 120 and download a part or all of the computer readable instructions for execution. Alternatively, computing device 102 may download pieces of the computer readable instructions, as needed, or some instructions may be executed at computing device 102 and some at computing device 120.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of executing in at least two domains a target instruction set stored in a memory of a computer having a processor, the method comprising:
storing in the memory a domain-switching instruction set configured to:
insert into the target instruction set at least one domain switch point specifying a target domain;
initiate execution of the target instruction set in an initial domain; and
upon detecting reaching a domain switch point in the target instruction set, transition execution of the target instruction set to the target domain specified with the domain switch point; and
executing the domain-switching instruction set on the processor.

2. The method of claim 1, at least one domain of the domains comprising:
a native executing domain configured to natively execute the target instruction set;
an interpretive executing domain configured to interpretively execute the target instruction set;
a virtual executing domain configured to execute the target instruction set in a virtual machine; or
a debugging domain configured to execute the target instruction set, the debugging domain managed by at least one debugging monitor.

3. The method of claim 1:
the inserting comprising: inserting a breakpoint at the domain switch point; and
the detecting comprising: detecting an invocation of the breakpoint.

4. The method of claim 1:
the inserting comprising: hooking at least one function invocation at the domain switch point with a handler; and
the detecting comprising: receiving an invocation of the handler.

5. The method of claim 1, the inserting comprising: reconfiguring at least one instruction in the target instruction set to access a proxy configured to transition execution to the second domain.

6. The method of claim 1, the domain-switching instruction set defining a domain switch controller configured to insert the at least one domain switch point in the target instruction set based on at least one domain switch criterion.

7. The method of claim 6, the at least one domain switch criterion selected from a group comprising:
an operation type of an operation in the target instruction set;
a resource type of a resource referenced in the target instruction set;
a performance criterion of an operation in the target instruction set;
a reliability criterion of an operation in the target instruction set;
a security criterion of an operation in the target instruction set; and
an affinity of an operation for executing within a domain.

8. The method of claim 1:
at least one domain switch point transitioning between a source domain and a target domain, and
the domain-switching instruction set configured to convert at least one object in the source domain according to an object format compatible with the target domain.

9. The method of claim 8, converting the object from the source domain to the target domain comprising:
identifying a preferred format of the object in the target domain, and
converting the object to the preferred format.

10. The method of claim 8, converting the object from the source domain to the target domain comprising: invoking a converter to convert the object in the source domain according to an object format compatible with the target domain.

11. The method of claim 10, the converter defined in:
the domain-switching instruction set;
the source domain;
the target domain; or
a debugging domain.

12. The method of claim 8:
the object comprising an instance identifier, and
the converting comprising: associating the instance identifier with the object converted according to an object format compatible with the target domain.

13. The method of claim 12:
the target instruction set comprising at least one instruction configured to compare the object with a second object associated with an instance identifier; and
the domain-switching instruction set configured to compare the object with the second object by comparing the instance identifier of the object with the instance identifier of the second object.

14. The method of claim 1, the domain-switching instruction set configured to: upon completing execution of the target instruction set, transition execution to the initial domain.

15. The method of claim 14:
the target instruction set producing at least one result object;
the domain-switching instruction set configured to: upon completing the target instruction set, convert the at least one result object according to an object format compatible with the initial domain.

16. The method of claim 1:
at least one operation in the target instruction set configured to execute in a first domain;
the domain-switching instruction set defining at least one equivalent operation configured to execute in a second domain; and
the domain-switching instruction set configured to: upon reaching the operation while executing in the second domain, execute the equivalent operation in the second domain.

17. The method of claim 16:
the operation generating at least one result object; and
the domain-switching instruction set configured to: upon completing execution of the equivalent operation in the second domain, convert the at least one result object according to an object format compatible with the first domain.

18. The method of claim 1, the domain-switching instruction set configured to:
upon receiving a stack trace request while executing the target instruction set:
select a stack trace domain among the at least two domains, and
execute the stack trace in the stack trace domain.

19. A computer-readable tangible medium comprising a processor-executable domain-switching instruction set configured to perform a method of executing in at least two domains a target instruction set stored in a memory of a computer having a processor, the method comprising:
inserting in the target instruction set at least one domain switch point specifying a target domain;
initiating execution of the target instruction set in an initial domain; and
upon detecting reaching a domain switch point in the target instruction set, transitioning execution of the target instruction set to the target domain specified with the domain switch point.

20. A method of executing in at least two domains a target instruction set stored in a memory of a computer having a processor, the method comprising:
storing in the memory a domain-switching instruction set defining at least equivalent operation configured to operate in a second domain, the domain-switching instruction set configured to:
insert into the target instruction set at least one domain switch point specifying a target domain by inserting a breakpoint at the domain switch point based on at least one domain switch criterion selected from a group comprising:
an operation type of an operation in the target instruction set;
a resource type of a resource referenced in the target instruction set;
a performance criterion of an operation in the target instruction set;
a reliability criterion of an operation in the target instruction set;
a security criterion of an operation in the target instruction set; and
an affinity of an operation for executing within a domain;
initiate execution of the target instruction set in an initial domain;
upon detecting reaching a breakpoint at a domain switch point in the target instruction set, transition execution of the target instruction set to the target domain specified with the domain switch point;
upon detecting an execution of an operation for which an equivalent operation is defined in the domain-switching instruction set:
transition execution of the instruction set from a current domain to the second domain,
invoke the equivalent operation, and
transition execution of the instruction set to the current domain; and
upon completing execution of the instruction set, transition execution of the instruction set to the initial domain; and
executing the domain-switching instruction set on the processor.
